(19) United States
(12) Patent Application Publication
(10) Pub. No.: US 2018/0035006 A1
(43) Pub. Date: Feb. 1, 2018

(54) PRINT TRANSFORMATION EFFECTS

(71) Applicant: KYOCERA Document Solutions Inc., Concord, CA (US)

(72) Inventor: Neil-Paul Bermundo, Concord, CA (US)

(73) Assignee: KYOCERA Document Solutions Inc., Concord, CA (US)

(21) Appl. No.: 15/224,331

(22) Filed: Jul. 29, 2016

(51) Int. Cl. H04N 1/387; G06F 3/12

(52) U.S. Cl. CPC H04N 1/387; G06F 3/1205; G06F 3/1248; G06F 3/1245; G06F 3/1265; G06F 3/1272; G06F 3/1254; H04N 2201/0094

(57) ABSTRACT

A method of printing a variant of an original page at a printer based on one or more selected transformation effects. Applying transformation effects can include modifying commands in a print job to adjust global page settings or parameters of individual elements on the page, and/or adding new elements to the page. As such, one or more variants of an original page can be generated at a printer from a digital original or scanned page, and the printer can print out one or more copies of each variant.

### BACKGROUND

### Field of the Invention

The present disclosure relates to printers, particularly a system and method for transforming pages being printed or copied.

### Background

Printers, such as multifunctional printers (MFPs), are often used to print multiple copies of the same document. In some situations, the document is a digital document that is transferred to the printer from another device, such as a computer or mobile device. In other situations, an MFP can copy a hard copy document by scanning it and then printing multiple copies of the document.

In either situation, the printer is normally configured to print copies of the digital or hard copy original that matches the original as closely as possible. However, in some cases users may desire to change the document's design for some or all copies of the document.

For example, a user who is printing signs, brochures, or other material for a conference may want to print copies that present the same content using different visual styles. Presenting the same content in different visual styles may help attract interest in the content. While conference attendees might ignore multiple exact copies of the same document, they might be more likely to review the content more often if they see it presented multiple times with different fonts, colors, or other design variations. Similarly, different visual styles may appeal to different attendees. Having multiple variations of a document available can allow different viewers to review a version produced in their preferred visual style, thus increasing the overall likelihood of a conference attendee reviewing and remembering the material.

Traditionally, to create multiple designs that present the same material in different visual styles, a user would need to manually generate each variant by altering attributes such as font styles, colors, and layouts. The user would then have to print or make copies of each variant manually. Producing and printing multiple variants of the same document can take significant amounts of time and effort. As such, many users may avoid producing multiple variants of a document, even if they would ideally prefer to do so.

What is needed is a system and method for automatically printing or copying one or more variants of an original document using a set of transformation effects that can alter the appearance of elements on a page before it is printed.

### SUMMARY

The present disclosure provides a method of printing a document variant at a printer. The printer can receive page data describing elements of a page. The printer can also receive one or more transformation effect selections that indicate modifications to the elements of the page. The printer can modify the elements of the page according to the transformation effect selections. The printer can then print the page according to the modified elements.

The present disclosure also provides a printer comprising a page description language interpreter, a graphics rendering component, and a print engine. The page description language interpreter can receive a print job that has page data commands describing elements of a page, and effect commands that indicate one or more selected transformation effects. The page description language interpreter can adjust parameters of the page data commands according to the transformation effects, to modify the appearance of the page and/or individual objects on the page. The page description language interpreter can also convert the commands into a format expected by the graphics rendering component. The graphics rendering component can generate an orderlist from the converted commands that includes low level instructions for printing the page at the print engine. The graphics rendering component can generate and adds low level instructions to the orderlist regarding transformation effects that add new elements to the page. The print engine can follow the low level instructions in the orderlist to print the page using one or more printer components.

The present disclosure also provides a printer comprising scanner components, an input device, an image processor, a page description language interpreter, a graphics rendering component, and a print engine. The scanner components can scan include at least one image sensor that can scan a physical page into a digital representation of the page. The input device can accept one or more transformation effect selections from a user. The image processor can modify the digital representation of the page according to the transformation effect selections, and prepare a print job that includes commands describing the page and the selected transformation effects. The page description language interpreter can adjust parameters of the page data commands according to transformation effects, to modify the appearance of the page and/or individual objects on the page. The page description language interpreter can also convert the commands into a format expected by the graphics rendering component. The graphics rendering component can generate an orderlist from the converted commands that includes low level instructions for printing the page. The graphics rendering component can add low level instructions to the orderlist regarding transformation effects that add new elements to the page. The print engine can follow the low level instructions in the orderlist to print the page using one or more printer components.

### BRIEF DESCRIPTION OF THE DRAWINGS

FIG. 1 depicts an embodiment of a printer.

FIG. 2 depicts a block diagram of the components of a printer.

FIG. 3 depicts a diagram of a printer's document processing components.

FIG. 4 depicts a plurality of exemplary types of transformation effects.

FIG. 5 depicts exemplary categories of transformation effects.

FIG. 6 depicts an exemplary options menu for selecting page effects.

FIG. 7 depicts an exemplary options menu for selecting object effects.

FIG. 8 depicts an exemplary options menu for selecting imaging filters.

FIG. 9 depicts an exemplary options menu for selecting pixmap blending masks.

FIG. 10 depicts an exemplary options menu for selecting pixmap screens.

FIG. 11 depicts an exemplary process in which transformation effects are applied at printer driver before a print job is sent to a printer.

FIG. 12 depicts exemplary processing levels for applying transformation effects at the printer.

FIGS. 13A-13B depict an exemplary process in which transformation effects are applied at a printer after receiving a print job from a printer driver.

FIG. 14 depicts exemplary syntax for printer job language (PJL) commands to apply page effects at a printer.

FIGS. 15A-15B depict exemplary syntax for PJL commands to apply object effects at a printer.

FIG. 16 depicts exemplary syntax for PJL commands to apply imaging filters at a printer.

FIG. 17 depicts exemplary syntax for PJL commands to apply pixmap blending masks at a printer.

FIG. 18 depicts exemplary syntax for PJL commands to apply pixmap screens at a printer.

FIGS. 19A-19B depict an exemplary process in which transformation effects are applied at a printer after scanning a page with its scanner components.

FIG. 20 depicts an example of variants of an original document being produced via one or more transformation effects.

### DETAILED DESCRIPTION

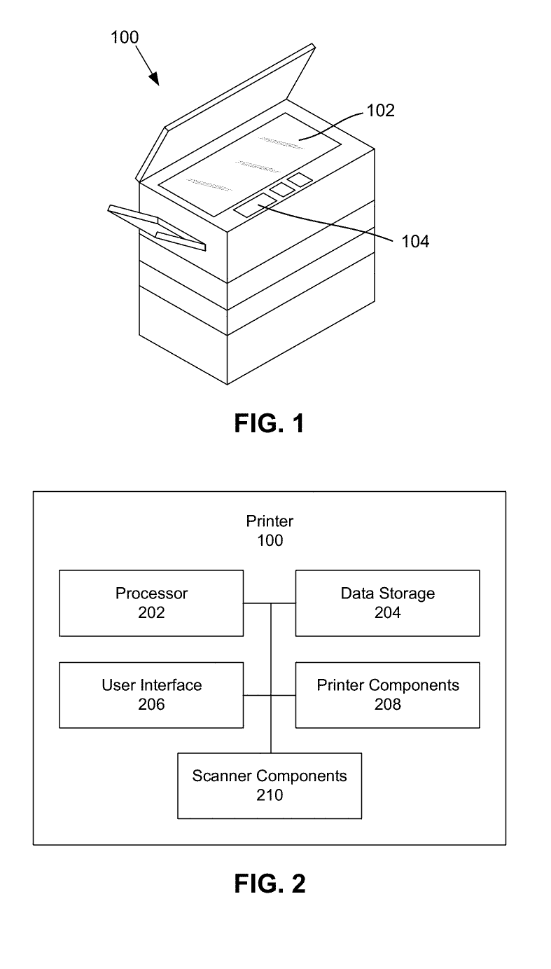

FIG. 1 depicts an embodiment of a printer 100. A printer 100 can be a device configured to print text and/or images on paper or other substrates. As shown in FIG. 1, in some embodiments the printer 100 can be a multifunctional printer (MFP) that combines printing, scanning, copying, faxing, and/or other functions into a single device. An MFP can be configured to print documents that have been digitally transferred to the MFP from another device over a wired or wireless data connection. By way of a non-limiting example, an MFP can be configured to print a document sent to it by a computer over a network connection. An MFP can also be configured to copy, or scan and print, documents placed on a platen 102 and/or passed through an auto-document feeder at the MFP. In alternate embodiments, a printer 100 can be a single function device that is configured to print documents that have been digitally transferred to it by another device.

In some embodiments, a printer 100 can comprise one or more input/output devices 104. The input/output devices 104 can be screens, buttons, keyboards, switches, dials, indicator lights, speakers, and/or any other type of input or output device. By way of a non-limiting example, an input/output device 104 can be a liquid-crystal display (LCD) screen mounted on an exterior housing. In some embodiments, one or more screens can be touch-sensitive. In other embodiments, users can interact with screens using other controls such as buttons or keyboards.

FIG. 2 depicts a block diagram of a printer's components. A printer 100 can comprise at least one processor 202, data storage 204, a user interface 206, and printer components 208. In some embodiment, such as embodiments in which the printer 100 is an MFP, the printer 100 can further comprise scanner components 210.

A processor 202 can be a chip, circuit, or controller configured to execute instructions to direct the operations of the printer 100, such as a central processing unit (CPU), application-specific integrated circuit (ASIC), field-programmable gate array (FPGA), graphics processing unit (GPU), or any other chip, circuit, or controller. In some embodiments a plurality of chips, circuits, and/or controllers can operate together to direct the operations of the printer 100.

Data storage 204 can be one or more internal and/or external digital storage devices, such as random access memory (RAM), read-only memory (ROM), electrically erasable programmable read-only memory (EEPROM), flash memory, digital tape, a hard disk drive HDD), a solid state drive (SSD), any/or any other type of volatile or non-volatile digital memory. The data storage 204 can store instructions executable by the processor 202 to operate the printer 100, including an operating system and/or applications.

The user interface 206 can comprise hardware and/or software elements for receiving instructions from users and/or displaying information to users. In some embodiments the user interface 206 can comprise graphical user interfaces and/or other interfaces operable by users through input/output devices 104.

The printer components 208 can be components that apply ink and/or toner to paper to print text and/or images onto the paper. In some embodiments, the printer components 208 can be laser printer components, such as laser diodes, lenses, mirrors, photoconductor drums, toner hoppers, charge rolls, fusers, and/or other components. In other embodiments, the printer components 208 can be inkjet printer components, such as print heads and ink cartridges. In still other embodiments, the printer components 208 can comprise components of any other desired type of color or monochrome printer. The printer 100 can further comprise one or more paper storage areas from which it can draw pieces of paper to be printed on by the printer components 208, such as paper drawers or trays, and/or other processing components such as a finisher.

The scanner components 210 can comprise one or more image sensors, such as contact image sensors (CIS), charge coupled devices (CCD), or image sensors of any other type. The image sensors can be configured to scan text and/or images on documents that are placed on a platen 102 or that are fed through a document feeder that sequentially pulls and scans individual pages from the document feeder.

The printer 100 can be configured to store digital representations of scanned documents in memory, such as in its data storage 204. Scanned documents can be printed with the printer components 208, stored for later retrieval, or transferred to other devices over a wired or wireless data connection. In some embodiments the printer components 208 and scanner components 210 can work together in a copy function to scan documents using the scanner components 210 and then print them using the printer components 208.

In some embodiments the printer 100 can further comprise fax components for faxing scanned documents, network components for transmitting data over the internet or any other data network, and/or ports for connecting to other devices, such as USB and Ethernet ports.

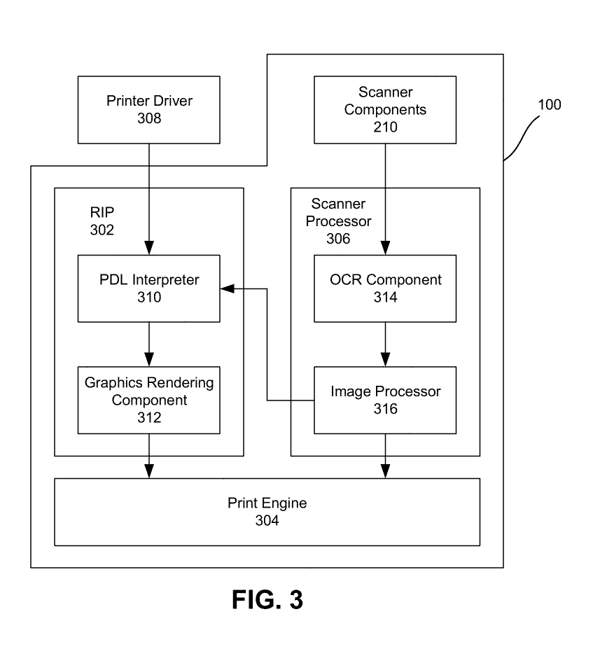

FIG. 3 depicts a diagram of a printer's document processing components. A printer 100 can comprise a raster image processor (RIP) 302 and a print engine 304. The RIP 302 can prepare an orderlist for the print engine 304. The orderlist can be a binary data representation of low-level graphics instructions that the print engine 304 can follow to produce markings on a piece of paper using the printer components 208. In some embodiments in which the printer 100 comprises a scanner, such as when the printer 100 is an MFP, the printer 100 can further comprise a scanner processor 306 that processes images scanned by the scanner components 210 before sending image data to the RIP 302 and/or print engine 304.

The RIP 302 can be firmware and/or software package that can prepare an orderlist from data representing a page to be printed. In some embodiments, the page data can be described by a print job received from a printer driver 308 running on an external device, such as a computer or mobile device. A printer driver 308 can be an application on the external device that can communicate with the printer 100 to submit print jobs to the printer 100. In alternate embodiments, the page data processed by the RIP 302 can be data describing a page scanned by the scanner components 210.

While in some embodiments the printer 100 can have its own RIP 302, in alternate embodiments the printer 100 can additionally or alternately use one or more cloud RIPs 302. A cloud RIP 302 can be an RIP 302 running on another printer, a server, or any other remote computing device with which the printer 100 can communicate over a network connection. In these embodiments, the printer 100 can lessen its processing load by transmitting data for one or more pages or print jobs to a cloud RIP 302, such that the cloud RIP 302 can generate an orderlist and return the orderlist to the printer 100.

A print job or other page data received by the RIP 302 can be represented using a page description language (PDL), such as PostScript, PCL (Printer Command Language), PDF (Portable Document Format), or XPS (XML Paper Specification). PDL code can include commands that describe the content, format, and/or layout of each individual element on a page, such as individual images and pieces of text. By way of a non-limiting example, when user instructs a computer to print a document or image, a printer driver 308 can be invoked that converts the computer's representation of that document or image into PDL code that is sent to the RIP 302 for interpretation and processing. In some embodiments or situations, individual PDL commands can be included with and/or wrapped within commands for a printer job language (PJL) that can describe changes to parameters and settings at the printer 100, as will be discussed further below.

As shown in FIG. 3, an RIP 302 can comprise at least one PDL Interpreter 310 and a Graphics Rendering Component 312. A PDL Interpreter 310 and the Graphics Rendering Component 312 can together process PDL and/or PJL code received from a source such as a printer driver 308 or a scanner processor 306.

A PDL Interpreter 310 can parse and interpret commands in received PDL and/or PJL code into a format expected by the Graphics Rendering Component 312. In some embodiments, the printer 100 can have multiple PDL Interpreters 310 that are each associated with a different PDL, such that each PDL Interpreter 310 can convert language-specific commands into a common format expected by the Graphics Rendering Component 312.

In some embodiments, a PDL Interpreter 310 can verify or validate commands in the received code, such as performing parameter checking, checking for values that are out of an expected range, and/or converting received values into an expected format or range. The PDL Interpreter 310 can convert received values to a different scale, into different units, and/or transform values into any other expected format or range. By way of a non-limiting example, when the PDL code represents the value of a particular parameter within a range between 1 and 10, but the Graphics Rendering Component 312 expects the value of that parameter to be within a range of 1 to 100, the PDL Interpreter 310 can multiply the original value by 10 to convert it to a corresponding value within the expected range. Each PDL Interpreter 310 can pass the validated and/or interpreted commands to the Graphics Rendering Component 312.

The Graphics Rendering Component 312 can receive validated and/or interpreted commands from a PDL Interpreter 310, and use the commands to generate an orderlist. By way of a non-limiting example, the Graphics Rendering Component 312 can translate drawing calls and other commands or parameters from the interpreted PDL/PJL commands into binary data instructions for the orderlist.

The orderlist generated by the RIP 302 can be passed to the print engine 304. The print engine 304 can comprise a graphics engine unit (GEU), a raster processing unit (RPU), and/or a halftone engine. The print engine 304 can also be linked with the printer components 208. The GEU can execute low-level binary data instructions in an orderlist to generate a raster representation of a document. In some embodiments the GEU can be a hardware component, while in other embodiments the GEU can be implemented in software and/or firmware. In some embodiments the RPU can be a firmware component that performs color conversation on the raster representation, overlays stamps or other images on the raster representation, rotates the page, and/or performs other operations on the raster representation before it is printed. The halftone engine can convert the raster representation into a pattern of dots that can be printed by the printer components 208.

In embodiments comprising a scanner processor 306, the scanner processor 306 can comprise an optical character recognition (OCR) component 314 and/or an image processor 316. In some embodiments the OCR component 314 and/or image processor 316 can process scanned representations of documents, and then pass them to the RIP 302 using PDL and/or PJL code for further processing. In alternate embodiments the components of the scanner processor 306 can pass a raster representation of the scanned document directly to the print engine 304. In these embodiments, the print engine 304 can process the received raster representation directly with its RPU and/or halftone engine without generating a new raster representation from an orderlist.

An OCR component 314 can perform image analysis to identify and/or recognize markings within a scanned image. By way of a non-limiting example, the scanner components 210 can scan a document and produce a raster representation of the document, such as a bitmap. The OCR component 314 can then analyze the raster representation to identify and/or extract readable text elements, such that the readable text can be converted into a searchable digital format. The OCR component 314 can pass information about recognized text elements to the image processor 316.

An image processor 316 can perform one or more image processing operations on a scanned image. By way of non-limiting examples, the image processor 316 can alter colors in a raster representation of a scanned image, or add text or other elements to the scanned image as overlays. As will be described below, in some embodiments the image processor 316 can apply one or more transformation effects 400 to elements on a page before passing information about the page to the RIP 302 or print engine 304.

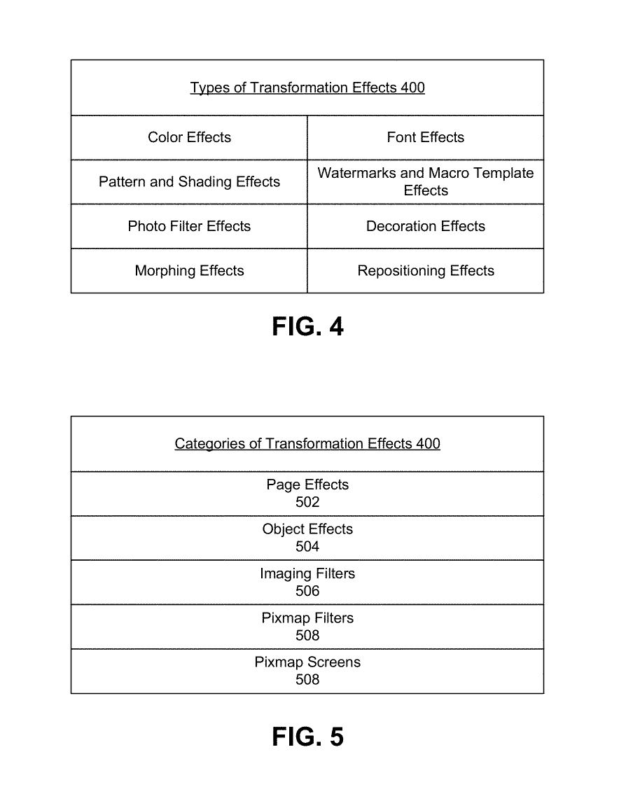

FIG. 4 depicts a plurality of exemplary types of transformation effects 400. The printer 100 can be configured to apply one or more transformation effects 400 to elements on a page before printing the page. Transformation effects 400 can comprise color effects, pattern and shading effects, photo filter effects, morphing effects, font effects, watermark and macro template effects, decoration effects, repositioning effects, and/or any effects of any other type. As will be described below, one or more transformation effects 400 can be applied at one or more stages when printing a page, such as within the printer driver 308, within the RIP 302, within the scanner processor 306, and/or within the print engine 304.

Color effects can be effects that alter the color of a page, or the color of one or more objects on a page. By way of a non-limiting example, a color effect can be replacing and/or filling the color of a line, object, or text with one or more desired colors, such as dark colors, bright or neon colors, or a gradient of colors. By way of another non-limiting example, a color effects can be altering the color space definitions for a page or an object, so that a color value in the original color space corresponds with a different color in the altered color space.

Pattern and shading effects can be effects that adds or changes patterned designs, shading, transparencies, and/or shadows on a page, or that adds or changes such elements to one or more objects on a page. By way of a non-limiting example, a pattern effect can be to superimpose a hash pattern over a page or a specific object on the page. By way of another non-limiting example, a shading effect can be to adjust the transparency of a raster image or text. By way of yet another non-limiting example, a shading effect can be to add a shadow or shading around all or part of an object.

Photo filter effects can be effects that change the contrast, brightness, and/or saturation of colors for one or more objects or an entire page. Photo filter effects can also be an effect that applies a filter to all or part of a page, such as making colors warmer or cooler, converting the image's colors to sepia tones, applying a negative film effect, or blurring images.

Morphing effects can be effects that adjust the size or shape of objects on a page. By way of non-limiting examples, morphing effects can include adjusting one or more scaling parameters to skew the shape and size of an object, distorting straight lines such that they are curved, and/or applying lens effects to expand, shrink, or balloon objects.

Font effects can be effects that alter the fonts used for text on a page. By way of non-limiting examples, font effects can be changing the font used for a portion of text, changing a font style between regular, bold, and/or italic, and/or changing the size of a font.

Watermark and macro template effects can be effects that add text or other images over or under some or all of a page. By way of a non-limiting example, preset or random text can be added as a watermark to one or more copies of a document. By way of another non-limiting example a background image, text, or images created according to a macro template can be added to one or more copies of a document.

Decoration effects can be effects that add decorations to a page. By way of a non-limiting example, a decoration effect can be to add decorative elements across all or part of a page, such as stars, leaves, glitter, light glares, or other floating objects. By way of another non-limiting example, decoration effects can be to add or change a border around an entire page, around an object such as a table, diagram, or image, or around any other portion of a page.

Repositioning effects can be effects that replace and/or reposition elements on a page, such as text and/or images. By way of a non-limiting example, a repositioning effect can be to rotate a portion of text from its original position. In some embodiments, the printer 100 can perform image analysis to interpolate background colors or patterns that would likely be behind existing objects, such that the objects can be moved to other locations and the space they previously occupied can be filled in with the interpolated colors or patterns.

As shown in FIG. 5, in some embodiments individual transformation effects 400 can be categorized as and/or implemented as a page effect 502, an object effect 504, an imaging filter 506, a pixmap blending mask 508, and/or a pixmap screen 510. By way of a non-limiting example a color effect that alters all colors on an entire page can be categorized as a page effect 502, while another color effect that alters the color of a single object can be categorized as an object effect 504.

Page effects 502 can be transformation effects 400 that set or change global parameters that can alter the overall appearance of an entire page. Page effects 502 can include: scaling an entire page to fit a larger or smaller paper size; tilting an entire page; adding a frame or border to a page; and/or global adjustments of all colors on a page, such as increasing or decreasing the intensity of all colors on a page.

Object effects 504 can be transformation effects 400 that set or change parameters that are specific to individual objects or elements within a page. Object effects 504 can include: adding new objects or markings to a page, such as pen markings, lines, raster images, or text; removing objects from a page; and/or changing an object's color, shape, size, or positioning. In some embodiments or situations, object effects 504 can be applied on an object-type basis, such that groups of objects of the same type can be modified by an object effect 504.

Imaging filters 506 can be transformation effects 400 that alter the appearance of groups of objects on a page. Imaging filters 506 can include adjusting shading, shadowing, reverse mapping, mirroring, repositioning, scaling, and/or pattern generation for one or more groups of objects, such as altering shadows for a group of shapes, adding hash patterns to a group of filled shapes, distorting or scaling groups of objects, and/or exaggerating colors of a group of objects. In some embodiments, an imaging filter 506 can be applied on a per-object basis and be performed during drawing or marking calls at the Graphics Rendering Component 312.

Pixmap blending masks 508 can be predefined pixel map images, such as bitmaps, that can be placed under, placed over, and/or blended together with other rendered page content to combine the rendered content with the predefined pixel map images. As such, some transformation effects 400 that alter the appearance of a page can be implemented by adding a pixmap blending mask 508 to other rendered content. By way of a non-limiting example, some decoration effects such as an overlay of stars, leaves, glitter, of light glares can be stored as a predefined pixel map image that can be overlaid over a page once other content has been rendered. By way of another non-limiting example, some watermark or macro template effects can be prerendered as pixel map images, such that they can be overlaid over a page once other content has been rendered. In some embodiments, a pixmap blending mask 508 can be applied on a per-object basis, or a per-page basis during marking calls at the Graphics Rendering Component 312, such that the Graphics Rendering Component 312 generates the pixmap blending mask 508 and combines it with other objects being drawn.

Pixmap screens 510 can be predefined pixel map screens that can alter or adjust a rendered page at the print engine 304 when the print engine 304 is preparing to print out the page. Pixmap screens 510 can be similar to halftone screens that are combined with rendered pages to create a pattern of dots that can be printed by printer components 208. By way of a non-limiting example, the same rendered page can be printed to appear differently by using different pixmap screens 510 that generate different final patterns of dots, such as increasing or decreasing the dot size to adjust perceived colors. In some embodiments, pixmap screens 510 can be applied and/or augmented by a color conversion process at the print engine 304.

Depending on the embodiment, situation, and/or specific set of transformation effects 400 that was selected, individual transformation effects 400 can be applied at the printer driver 308, at the RIP 302, at the print engine 304, and/or at the scanner processor 306.

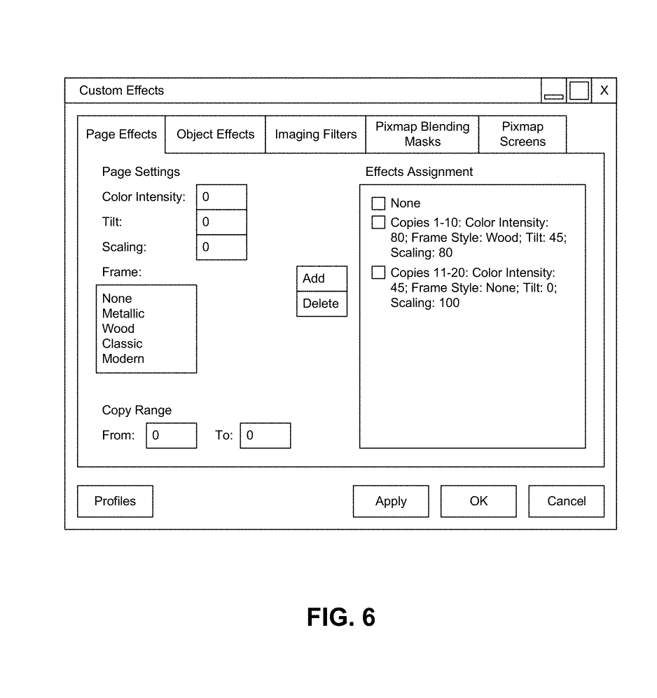

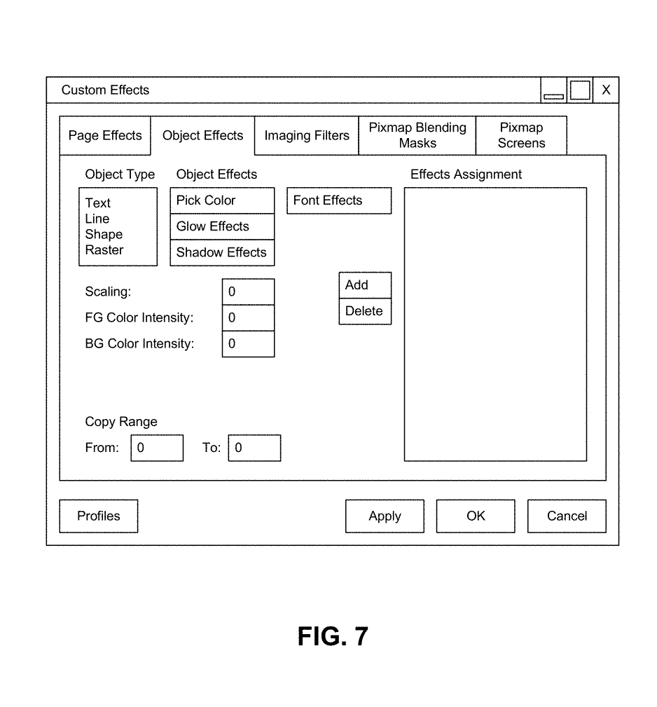

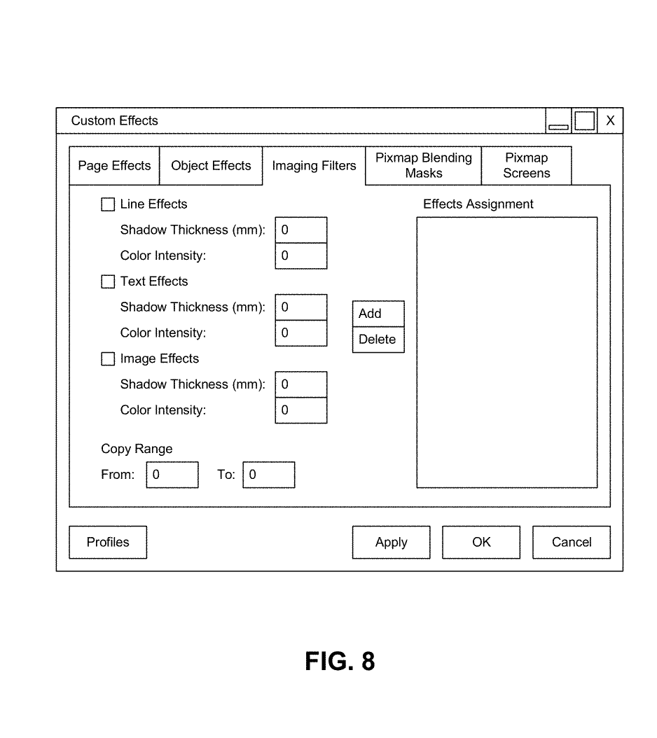

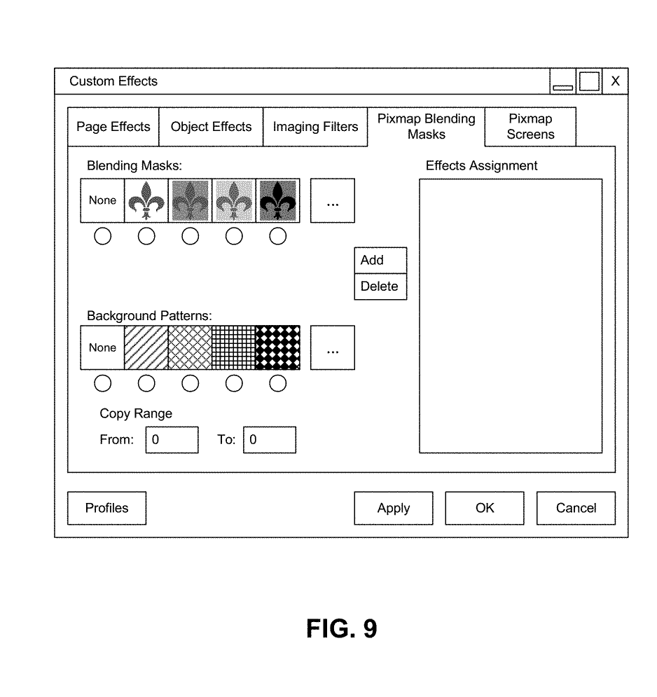

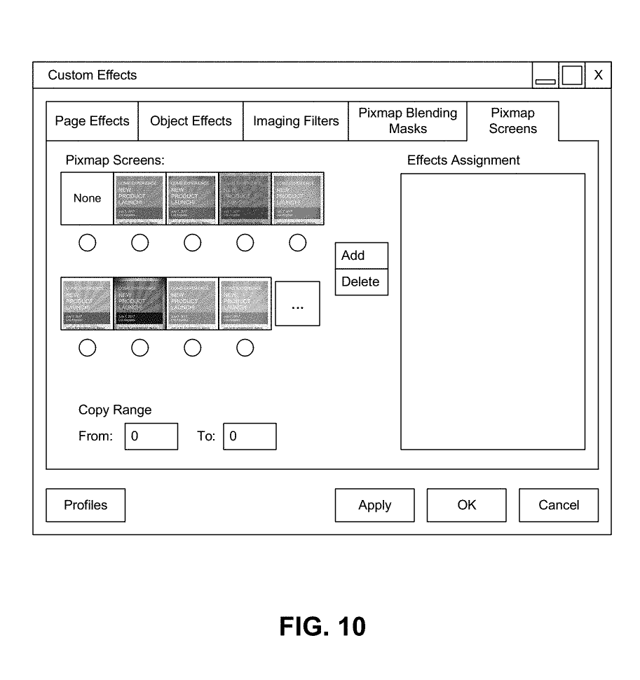

FIGS. 6-10 depict non-limiting exemplary menus that can be displayed on a computer or other device with a printer driver 308 when the printer driver 308 is activated to submit a print job from the device to the printer 100. These exemplary menus can present options to users such that a user can select particular set of transformation effects 400 to apply to a document, as well as options or parameters for each selected transformation effect 400. FIG. 6 depicts an exemplary options menu for selecting page effects 502, including controls to select the page's color intensity, tilt, scaling, and/or frame. Similarly, FIG. 7 depicts an exemplary options menu for selecting object effects 504, including controls to select an object type and specific effects to apply to objects of that type, including colors, glow effects, shadow effects, and/or font effects, as well as scaling factors and intensity factors for foreground and background colors. FIG. 8 depicts an exemplary options menu for selecting imaging filters 506, including controls for selecting a shadow thickness and/or color intensity for lines, text, and/or images. FIG. 9 depicts an exemplary options menu for selecting pixmap blending masks 508, including controls for selecting a particular blending mask and/or background pattern. FIG. 10 depicts an exemplary options menu for selecting pixmap screens 510, including controls for selecting a particular pixmap screen to apply to a page.

As shown in FIGS. 6-10, each selected set of transformation effects 400 can be applied to a specific range of copies of the page. By way of a non-limiting example, FIG. 6 depicts the “Effects Assignment” portion of the options menu displaying one set of transformation effects 400 to apply to the first ten copies of a page, and a different set of transformation effects 400 to apply to the next ten copies of the page. As such, settings selected via the printer driver 308 for different ranges of copies can result in the same original page being printed with different effects.

In some embodiments, a printer driver 308 can present a “Random Effects” option to a user, that if selected can generate a random set of transformation effects 400 to apply to a document for some or all copies. By way of a non-limiting example, a user can select the “Random Effects” option to have the printer driver 308 randomly select sets of transformation effects 400, of a “Custom Effects” option to view the menu shown in FIGS. 6-10 and select specific transformation effects 400 for a print job.

While FIGS. 6-10 depict exemplary menus that can be displayed by a printer driver 308, when the printer 100 is used to copy a page with its scanner components 210 similar menus or options can be displayed through the printer's user interface 206 and/or input/output devices 104. By way of a non-limiting example a screen on the printer 100 can display a user interface 206 through which a user can select standard copy options such as selecting a number of copies to print, finishing options, page rotation, page scaling, and/or other options. In these embodiments, the user interface 206 can also display an option such as “Advanced” or “Effects” through which options similar to those shown in FIGS. 6-10 can be displayed, such that the user can select desired transformation effects 400 to apply to the page being scanned and/or copied. As with options displayed via the printer driver 308, the options displayed directly by the printer's user interface 206 can be configured to allow a user to select different transformation effects 400 for different copy ranges, and/or select random effects.

In some embodiments or situations in which the printer 100 receives a print job from a printer driver 308 on another device, the printer driver 308 can apply some or all transformation effects 400 prior to sending the print job to the printer 100. When the printer driver 308 applies the transformation effects 400, it can send each copy range that has a different set of transformation effects 400 as a unique print job to the printer 100. In other embodiments or situations, the printer driver 308 can send a single print job to the printer 100 that includes commands indicating selected transformation effects 400 for each copy range, such that the printer 100 can apply the transformation effects 400 as it processes the print job and prepares the page for printing, such as applying transformation effects 400 at the RIP 302 and/or print engine 304.

In other embodiments or situations in which the printer 100 scans a document with its scanner components 210, the scanner processor 306 can process the scanned representation of each page and then either pass data about the page to the RIP 302 for further processing or directly to the print engine 304 for printing. As such, in these embodiments or situations transformation effects 400 can be applied at the scanner processor 306, at the RIP 302, and/or at the print engine 304.

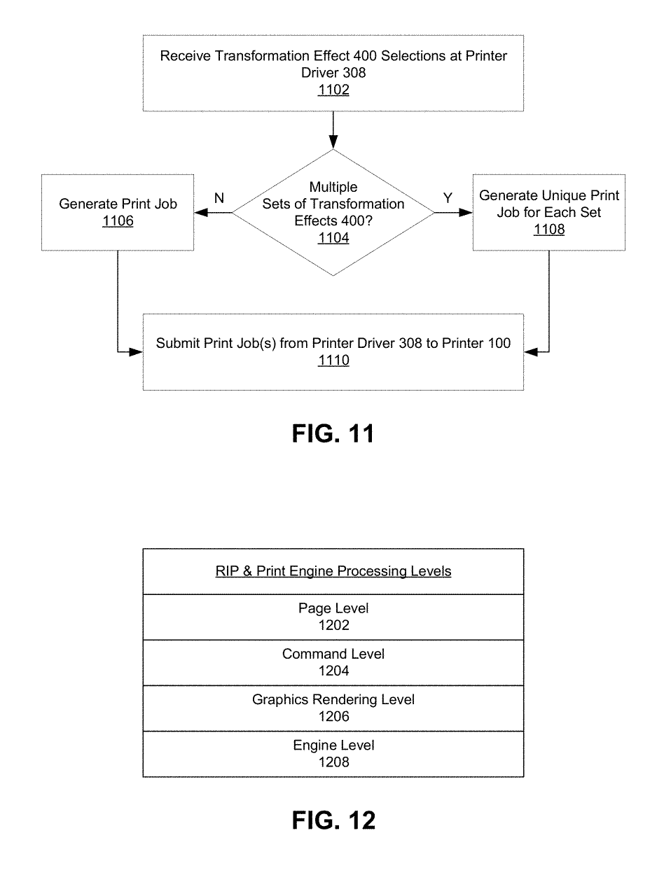

FIG. 11 depicts an embodiment of a process that can be used in embodiments in which transformation effects 400 are applied at the printer driver 308 before a print job is sent to the printer 100. At step 1102 the printer driver 308 can receive a user's selection of transformation effects 400. By way of a non-limiting example, the printer driver 308 can display options menus such as those shown in FIGS. 6-10 to inform the user which transformation effects 400 are available and receive commands regarding which transformation effects 400 to apply to which copies.

At step 1104, the printer driver 308 can determine whether multiple sets of transformation effects 400 were selected for different ranges of copies. If the printer driver 308 determines that only a single set of transformation effects 400 were selected that apply to all copies, the printer driver 308 can move to step 1106 to generate a print job using the selected transformation effects 400. However, if the printer driver 308 determines that different sets of selected transformation effects 400 are applicable to different ranges of copies, the printer driver 308 can move to step 1108 to generate unique print jobs for each range of copies.

At steps 1106 and 1108, the printer driver 308 can apply the selected transformation effects to the page to create an internal representation of the page that differs from the original page shown to the user on the device. By way of a non-limiting example, when a user selected transformation effects 400 that change the original font, font size, and font color of a piece of text, the printer driver 308 can create or adjust its internal representation of the page that adjusts that piece of text accordingly. The printer driver 308 can then generate a print job with PDL/PJL code that describes the adjusted internal representation. As such, the print job can directly indicate to the printer 100 how to render the printer driver's adjusted representation of the page, without further adjustment by the printer 100.

At step 1110, the printer driver 308 can submit each print job generated during step 1106 or step 1108 to the printer 100 to be printed. The printer 100 can process each print job as if it were any other print job, and directly follow the commands in the print job with its RIP 302 and print engine 304 to print the page. When the printer driver 308 submits multiple unique print jobs that correspond to different sets of transformation effects 400 for different copies of the same original page, the printer 100 can follow each distinct print job separately without considering each set of copies to be the same document.

In some embodiments or situations the printer driver 308 can apply some selected transformation effects 400 itself, but include commands for other selected transformation effects 400 within each unique print job. As such, the printer 100 can apply additional transformation effects 400 to the representation of the page described by a print job, as will be described further below.

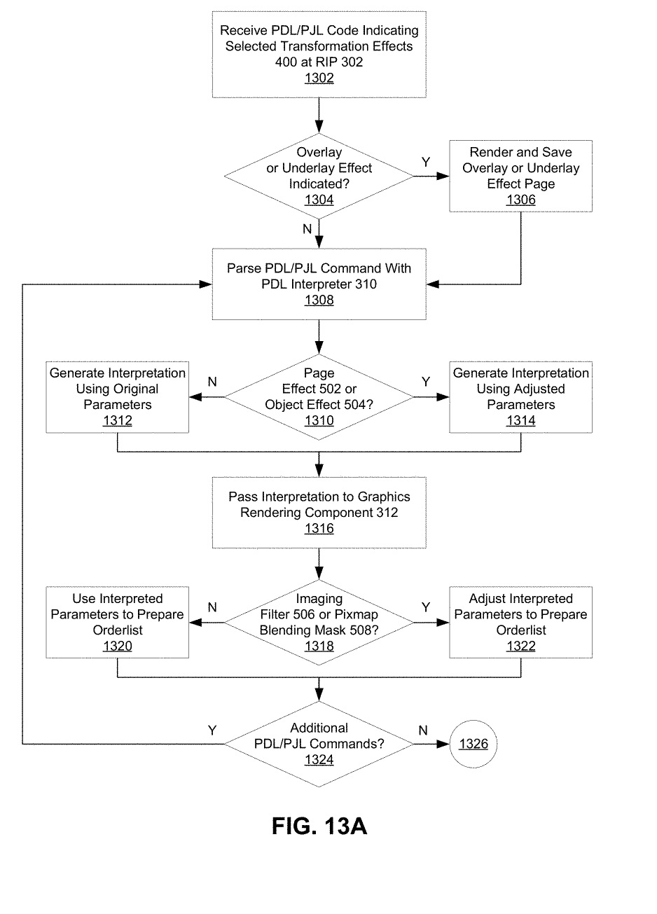

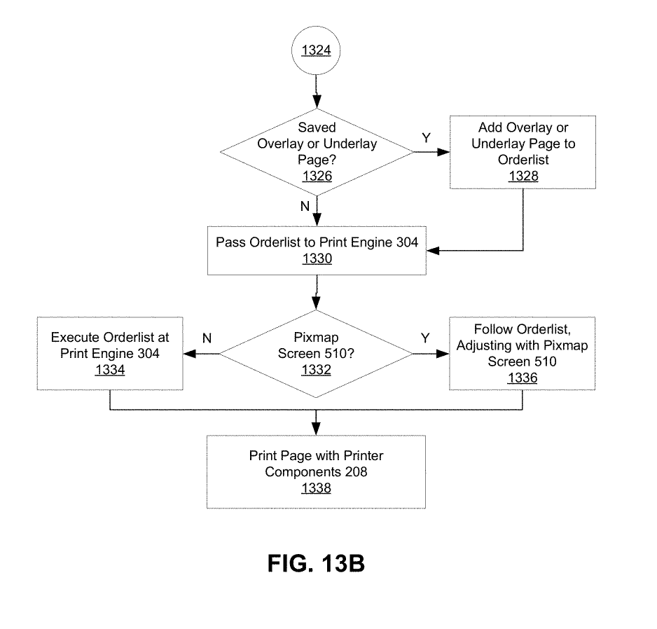

In alternate embodiments, the printer driver 308 can create unique print jobs for each copy range with different selected transformation effects 400 using one or more cloud RIPs 302. The RIPs 302 can return orderlists to the printer driver 308 that are specific to each set of transformation effects 400. The printer driver 308 can thus submit each orderlist to the printer 100 for printing as separate print jobs, without the printer 100 applying the transformation effects 400 itself. By way of a non-limiting example, when a user selected different sets of transformation effects 400 for each of three different copy ranges, the printer driver 308 can submit the same print job to three different cloud RIPs 302 but send different commands to each cloud RIP 302 that indicates a different set of transformation effects 400. Each cloud RIP 302 can follow a process with steps substantially similar to those described below with respect to FIG. 13 for a local RIP 302, to generate an orderlist that applies the selected transformation effects 400. The cloud RIPs 302 can return orderlists to the printer driver 308, and the printer driver 308 can then forward the orderlists to the printer 100 such that it can follow the orderlist to print each variant of the original page using its print engine 304. In some embodiments, the printer driver 308 can attempt to use cloud RIPs 302 if any are available at the time a print job is started, but use the process of FIG. 13 to instruct the printer 100 apply transformation effects 400 itself within its local RIP 302 if no cloud RIPs 302 are available.

FIG. 12 depicts an embodiment of processing levels for applying transformation effects 400 at the printer 100. Although in some embodiments one or more transformation effects 400 can be applied at the printer driver 308 as shown in FIG. 11, in other embodiments one or more transformation effects 400 can be selected at the printer driver 308 but be applied at the printer 100, such as during processing steps performed at the RIP 302 and/or print engine 304. In these embodiments, selected transformation effects 400 can be applied at a page level 1202, at a command level 1204, at a graphics rendering level 1206, and/or at an engine level 1208. These processing levels can also be followed in alternate embodiments or situations discussed below in which the RIP 302 and/or print engine 304 applies transformation effects 400 on page data received from the scanner processor 306. In some embodiments, applying different types of transformation effects 400 at different processing levels can assist in reducing processing load and/or avoiding processing bottlenecks. In some embodiments, transformation effects 400 at some or all processing levels can be accessed by the printer 100 using hashes or lookup tables.

Transformation effects 400 that can be applied at the page level 1202 can be effects that adjust default global settings for the page, and can be performed as the default PDL page configuration is being set up. As such, the page configuration can provide an initialized data structure that can override other default page settings. By way of non-limiting examples, effects at the page level 1202 can change the default page size or scaling. In some embodiments, transformation effects 400 at the page level 1202 can also be overlay or underlay pages that can be separately rendered and later combined with a full page of other rendered content, such as a border, a page of decoration effects, or a watermark page generated from a macro or template. By way of a non-limiting example, a page level effect can be a pixmap blending mask 508 that can be applied over or under a page.

Transformation effects 400 applied at the command level 1204 can be effects that can be implemented by modifying received PDL and/or PJL commands. By way of a non-limiting example when PDL commands in a print job have parameters indicating that a particular shape was originally set as being colored red and being located at a particular location on the page, but transformation effects 400 were selected to recolor the shape blue and reposition it to a different location, the parameters can be modified from their original values at the command level 1204 such that the parameters instead specify the modified color and location. By way of other non-limiting examples, transformation effects 400 implemented at the command level 1204 can be to adjust command parameters to change color spaces, color definitions, pen selections, scaling, and/or other settings that apply to attributes of text, shapes, raster images, and other objects.

In some embodiments the PDL Interpreter 310 can apply transformation effects 400 at the command level 1204 as it parses and interprets commands for the Graphics Rendering Component 312. By way of a non-limiting example, in addition to converting PDL commands into a format expected by the Graphics Rendering Component 312, the PDL Interpreter 310 can also apply transformation effects 400 by modifying parameters of the commands to change page and/or object attributes before the PDL Interpreter's interpretation of the commands are sent to the Graphics Rendering Component 312.

Transformation effects 400 that can be applied at the graphics rendering level 1206 can be effects that can be implemented by adjusting algorithms used to render new objects and/or add new rendered content to existing objects. By way of non-limiting examples, algorithms can be adjusted to change positioning of new page content, scale new content, change colors or patterns on new objects, add new colors or patterns over existing objects, making new objects partially transparent, or to add effects to objects such as shadows, glows, or reflections. In some embodiments, the Graphics Rendering Component 312 can implement transformation effects 400 at the graphics rendering level 1206 as it prepares low level binary instructions for the print engine 304 in an orderlist.

Transformation effects 400 that can be applied at the engine level 1208 can be effects that can be implemented by adjusting a pattern of dots used by printer components 208 to print the document, before the document is printed. In some embodiments predefined, precompiled, or installed pixmap screens 510 can be stored as resources that can by dynamically loaded and applied before, after, or at the same time as halftone screens. By way of non-limiting examples, the normal dot pattern that would otherwise be created with a halftone screen can be altered with a predefined pixmap screen 510 or color conversion routine. In some embodiments, the print engine 304 can implement transformation effects 400 at the engine level 1208.

FIGS. 13A-13B depict an embodiment of a process that can be used in embodiments in which transformation effects 400 are applied at the printer 100 after receiving a print job from a printer driver 308.

At step 1302 the printer 100 can receive a print job from a printer driver 308 running on a computer or other device. The print job can include PDL and/or PJL code prepared by a printer driver 308. The print job can include commands that describe elements of the page as it appeared to a user of the computer or other device that submitted the print job via the printer driver 308. The print job can also include commands that specify parameters of transformation effects 400 selected by the user via the printer driver 308, or parameters of transformation effects 400 that were randomly selected by the printer driver 308. By way of a non-limiting example, a user can have selected specific transformation effects 400 via the printer driver 308 through options menus such as those shown in FIGS. 6-10, and the printer driver 308 can prepare the print job by including commands that identify the chosen transformation effects 400 and their parameters.

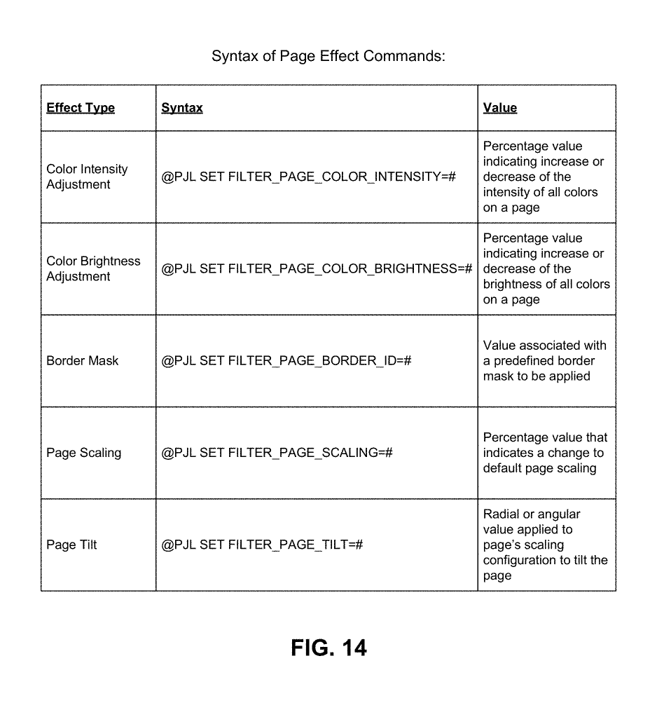

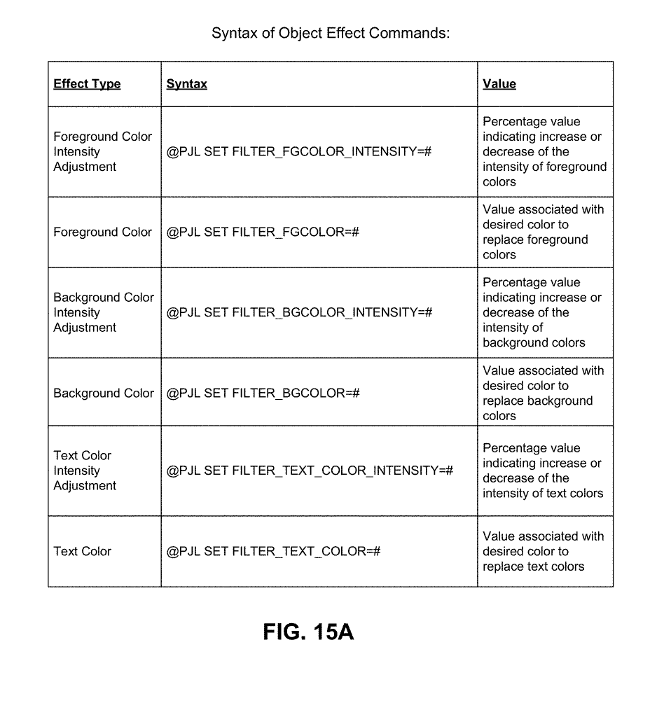

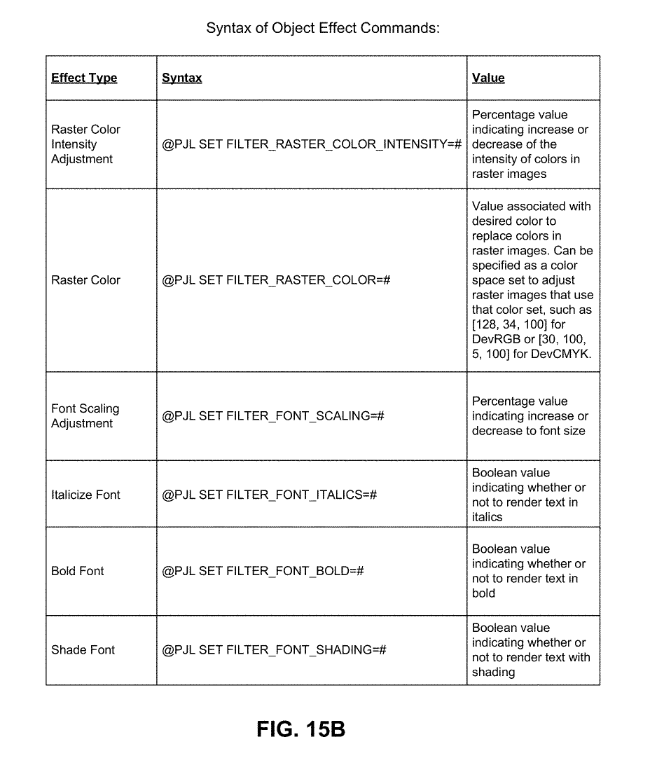

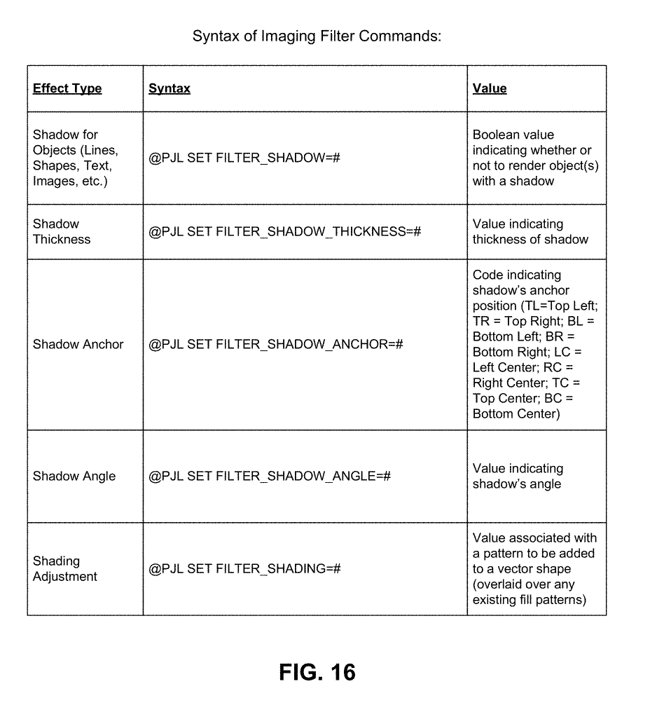

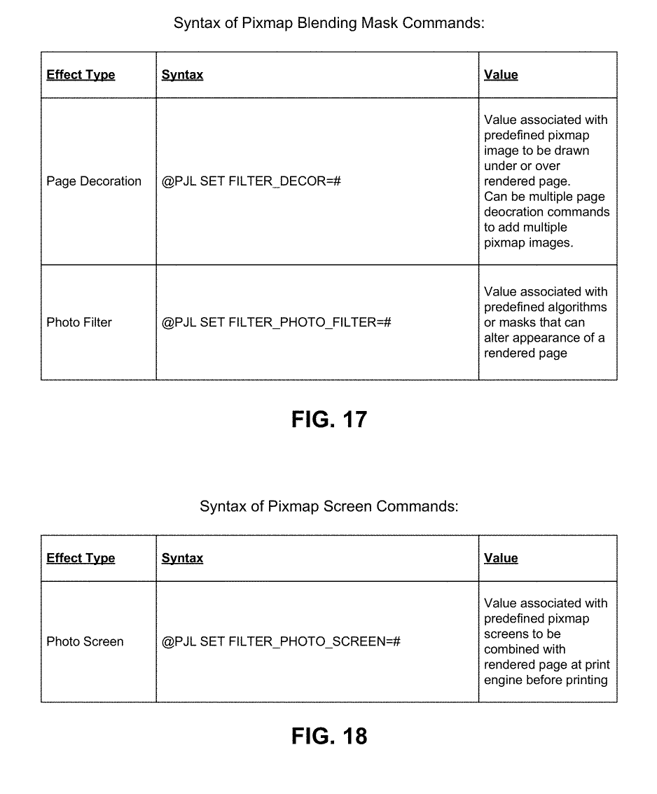

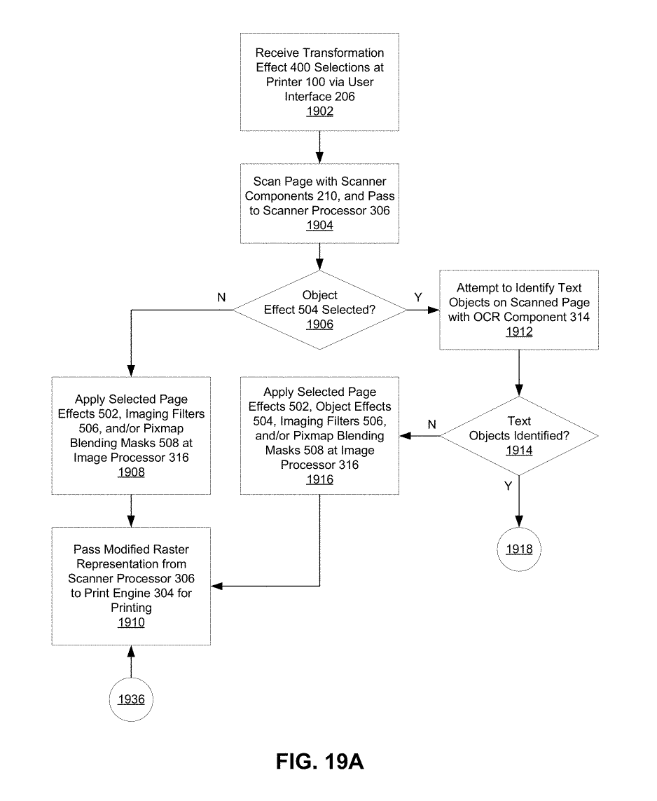

In some embodiments, a print job prepared by the printer driver 308 can specify commands regarding original elements of the page using PDL commands, while additional PJL commands before and/or after a set of PDL commands can indicate information about selected transformation effects 400. In some embodiments or situations, PJL commands can be instructions that indicate selected transformation effects 400 that can modify original elements of the page that are described by later PDL commands within the print job. By way of non-limiting examples, FIGS. 14-18 depict syntax for a plurality of exemplary PJL commands that can be included in a print job to instruct the RIP 302 and/or print engine 304 to apply desired transformation effects 400. FIG. 14 depicts non-limiting exemplary syntax for PJL commands to apply page effects 502, including color adjustments, border masks, and page scaling and tilting. FIGS. 15A-15B depict non-limiting exemplary syntax for PJL commands to apply object effects 504, including setting and adjusting colors for foreground objects, background objects, text, and raster images, as well as adjusting font attributes. FIG. 16 depicts non-limiting exemplary syntax for PJL commands to apply imaging filters 506, such as adding and adjusting shadows and shading to objects. FIG. 17 depicts non-limiting exemplary syntax for PJL commands to apply pixmap blending masks 508, including page decorations and photo filters. FIG. 18 depicts non-limiting exemplary syntax for PJL commands to apply pixmap screens 510, including photo screens. In alternate embodiments, the PJL commands can use different syntax for these and other transformation effects 400, and/or commands regarding transformation effects 400 can be indicated with PDL commands or any other type of message or data.

Returning to FIG. 13A, at step 1304 the printer 100 can review commands in the print job to determine if the commands specify any transformation effects 400 that can be implemented as overlay or underlay pages, such as borders, watermarks, macro templates, or decoration effects, that can be rendered as separate pages that can be later combined with other content. If no overlay or underlay effects were specified, the printer 100 can move to step 1308. If the print job specifies any overlay or underlay effects, the printer 100 can move to step 1306 and render a separate page with the selected overlay or underlay effects. In some embodiments, the overlay or underlay page can be rendered by elements of the RIP 302, such as the Graphics Rendering Component 312. The rendered overlay or underlay page can be stored in memory for use later in the process. In alternate situations, if the print job specifies overlay or underlay effects that have been pre-rendered and are already stored as a resource in memory, the printer 100 can locate the resource and prepare it for use later in the process. After preparing a page with the selected overlay or underlay effects, the printer 100 can move to step 1308.

At step 1308, the PDL Interpreter 310 can process a command in the received print job, such as a PDL or PJL command. If the PDL Interpreter 310 determines at step 1310 that the command does not relate to a page effect 502 or object effect 504, the PDL Interpreter 310 can perform default operations at step 1312 to interpret the command into a format expected by the Graphics Rendering Component 312. However, if at step 1310 the PDL Interpreter 310 determines that the command does relate to a page effect 502 or object effect 504, at step 1314 the PDL Interpreter 310 can interpret the command into the expected format as well as modifying the command to apply the appropriate transformation effect 400. By way of a non-limiting example, when the print job includes a PJL command for a particular page effect 502 that alters the page's scaling, such as a page scaling command with the syntax shown in FIG. 14, the PDL Interpreter 310 can prepare its interpretation of the print job's commands such that the page size is scaled from its original size by a percentage specified in the PJL command. By way of another non-limiting example, when the print job includes a PJL command that applies a text transformation to change the font for a piece of text from its original font, the PDL Interpreter 310 can alter the font parameters from the original parameters to instead instruct the Graphics Rendering Component 312 to use the new font when rendering the text.

In some embodiments the PDL Interpreter 310 can store a pair of functions for implementing each type of command at the command level 1204. In some of these embodiments, one function from a pair can be accessed via a hash or lookup table, such that the printer 100 can avoid costlier checks of conditional if/else statements. By way of a non-limiting example, for a particular type for command, the PDL Interpreter 310 can use a hash or lookup table to use either a default function during step 1312 if no corresponding transformation effect 400 was indicated in the print job, or an alternate effects function during step 1314 if a corresponding transformation effect 400 was indicated in the print job. In some embodiments, a default function can be identified using a “command_function( )” naming scheme, while an alternate effects function can be identified using a “command_function_ex( )” naming scheme.

At step 1316, after the PDL Interpreter 310 has generated an interpretation of the print job commands in the format expected by the Graphics Rendering Component 312 using either the original parameters or altered parameters to apply a page effect 502 or object effect 504, the interpreted command can be passed to the Graphics Rendering Component 312.

At step 1318, the Graphics Rendering Component 312 can determine whether the interpreted command indicates an imaging filter 506 or a pixmap blending mask 508 should be applied. If the command does not indicate application of an imaging filter 506 or pixmap blending mask 508, the Graphics Rendering Component 312 can move to step 1320 to prepare low-level instructions that correspond to the interpreted command. The low-level instructions can be included in an orderlist that will be followed by the print engine 304. However, if at step 1318 the interpreted command is found to indicate that an imaging filter 506 or a pixmap blending mask 508 is to be applied, the Graphics Rendering Component 312 can at step 1322 prepare adjusted low-level instructions that will render the page content using the selected imaging filter 506 or pixmap blending mask 508.

In some embodiments the Graphics Rendering Component 312 can store a pair of functions for implementing each type of command at the graphics rendering level 1206. In some of these embodiments, one function from a pair can be accessed via a hash or lookup table, such that the printer 100 can avoid costlier checks of conditional if/else statements. By way of a non-limiting example, for a particular type for command, the Graphics Rendering Component 312 can use a hash or lookup table to use either a default function during step 1320 if no corresponding transformation effect 400 was indicated in the print job, or an alternate effects function during step 1322 if a corresponding transformation effect 400 was indicated in the print job. In some embodiments, a default function can be identified using a “graphics_function( )” naming scheme, while an alternate effects function can be identified using a “graphics_function_ex( )” naming scheme.

At step 1324, the printer 100 can review the print job to determine if there are additional commands that have not yet been processed. If additional commands are present, the process can return to step 1308 to process the next command. In some embodiments, different commands can be simultaneously processed at different levels. By way of a non-limiting example, the PDL Interpreter 310 can be processing one command while the Graphics Rendering Component 312 processes another command that has already been processed by the PDL Interpreter 310.

If at step 1324 the printer 100 determines that all commands have been processed, such that the orderlist contains low-level instructions for printing all of the page elements in their original or adjusted form, the printer 100 can move to step 1326.

At step 1326, the printer 100 can determine if an overlay and/or underlay page was generated earlier during step 1306. If an overlay or underlay page was generated earlier, the Graphics Rendering Component 312 can modify the orderlist at step 1328 such that an overlay page will be printed on top of the other rendered content, and/or an underlay page will be printed under the other rendered content.

At step 1330, the RIP 302 can pass the generated orderlist to the print engine 304.

At step 1332, the print engine 304 can determine if the orderlist indicates that a pixmap screen 510 should be applied. If no pixmap screen 510 was selected, the print engine 304 can execute the orderlist at step 1334 using a halftone screen to prepare a dot pattern that can be printed using the printer components 208 at step 1338. However, if a pixmap screen 510 was selected, the print engine 304 can apply the pixmap screen 510 at step 1336 as it follows the orderlist to prepare the final dot pattern. By way of a non-limiting example, the print engine 304 can use halftone screens as well as selected pixmap screens to prepare the final dot pattern. The final dot pattern can be printed at step 1338.

In some embodiments, the printer 100 can use one or more cloud RIPs 302 to offload one or more steps in the process of FIG. 13. By way of a non-limiting example, if applying particular transformation effect 400 is expected to be processor and/or memory intensive, the printer 100 can reduce its load by offloading application of that transformation effect 400 to a cloud RIP 302. The cloud RIP 302 can perform one or more steps of FIG. 13 and return the result to the printer 100 such that it can use the result locally in later steps.

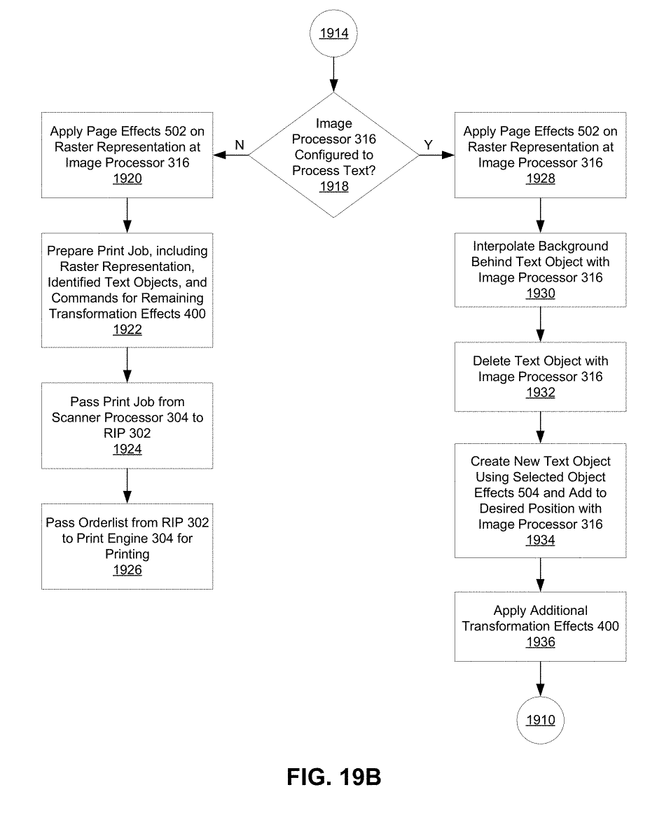

FIGS. 19A-19B depict an exemplary embodiment of a process that can be used in embodiments in which transformation effects 400 are applied at the printer 100 after scanning a page with its scanner components 210.

At step 1902 the printer 100 can receive a user's selection of transformation effects 400. By way of a non-limiting example, the printer's user interface 206 can display options menus similar to those shown in FIGS. 6-10 to inform the user which transformation effects 400 are available and receive commands regarding which transformation effects 400 to apply to which copies. In alternate embodiments or situations, a user can input commands that instruct the printer 100 to generate a random set of transformation effects 400 for one or more copy ranges.

At step 1904 the printer's scanner components 210 can scan a page on the platen 102 or through an automatic document feeder, to generate and store a digital raster representation of the scanned page in memory. The raster representation can be passed to the scanner processor 306.

At step 1906, the scanner processor 306 can determine whether the selected set of transformation effects 400 include any object effects 504. If no object effects 504 were selected, the scanner processor 306 can move to step 1908 and apply other selected transformation effects 400 at the image processor 316. By way of non-limiting examples, the image processor 316 can alter the scanned raster representation with page effects 502 such as changing the page size, with imaging filters 506 such as rendering and adding hash patterns to portions of the page, and/or with pixmap blending masks 508 such as adding a prerendered overlay page over the raster representation. The image processor 316 can forward the altered raster representation to the print engine at step 1910 to be printed. In some embodiments or situations, the scanner processor 306 can additionally inform the print engine 304 of any remaining selected transformation effects 400 that are to be applied at the print engine 304 during step 1910, such as pixmap screens 510.

Returning to step 1906, if object effects 504 were selected, the scanner processor 306 can move to step 1912 and process the scanned raster representation with the OCR component 314 to attempt to identify text objects. The OCR component 314 can analyze the page to identify the size, position, and/or content of individual text objects. By way of non-limiting examples, the OCR component 314 can identify text, extract the text such that it is searchable and/or editable, and/or record the position and dimension of a bounding box around the text. After processing the raster representation of the page with the OCR component 314, the scanner processor 306 can move to step 1914.

At step 1914, the scanner processor 306 can determine whether the OCR component 314 identified any text objects on the page. If it did not, the scanner processor 306 can move to step 1916 and implement selected transformation effects 400 at the image processor 316, including object effects 504 not related to text processing. In addition to applying page effects 502, imaging filters 506 and/or pixmap blending masks 508 at the image processor 316 as described in step 1908, the image processor 316 can also apply object effects 504 on shapes or images during step 1916. By way of non-limiting examples, the image processor 316 can use edge detection or other image analysis techniques to identify objects on the page and then alter their color, adjust their size or position, or perform any other type of editing or adjustment. In some embodiments, the image processor 316 can use colors and patterns around an individual object to interpolate a likely background behind an object, such that the area behind the object can be filled in with the interpolated background when the object's size is made smaller or the object is moved from its original location. After step 1916, the image processor 316 can forward the altered raster representation to the print engine at step 1910 to be printed. In some embodiments or situations, the scanner processor 306 can additionally inform the print engine 304 of any remaining selected transformation effects 400 that are to be applied at the print engine 304 during step 1910, such as pixmap screens 510.

In alternate embodiments or situations, if object effects 504 were selected but none of the selected object effects 504 apply to text objects, the scanner processor 306 can move directly from step 1906 to step 1916 without processing the page with the OCR component 314 at step 1912.

Returning to step 1914, if the scanner processor 306 determines that text objects were recognized by the OCR component during step 1912 and object effects 504 were selected, the scanner processor 306 can move to step 1918.

From step 1918 the scanner processor 306 can move to either step 1920 or step 1922. The scanner processor 306 can move to step 1920 to prepare a print job for the RIP 302, such that the RIP 302 can apply at least some selected transformation effects 400 including object effects 504 applicable to identified text objects. Alternately, the scanner processor 306 can move to step 1928 to apply transformation effects 400 itself, including object effects 504 applicable to identified text objects. In some embodiments the printer's image processor 316 can be configured to process text, such that in these embodiments the printer 100 can move to step 1928 from step 1918. In alternate embodiments the printer 100 can have a different type of image processor 316 that is not configured to process text, such that in these embodiments the printer 100 can move to step 1920 from step 1918. In still other embodiments, the printer 100 can choose between moving to step 1920 and step 1928 from step 1918 based on the image processor's current processing load or other factors.

At step 1920, the image processor 316 can perform some or all selected page effects 502 on the scanned raster representation, such as adjusting the page size. In some embodiments the image processor 316 can also delete or erase identified text objects on the raster representation, such as by interpolating a background behind identified text and overlaying a box filled with the interpolated background over the identified text. In some embodiments, the image processor 316 can perform one or more object effects 504 on non-text objects, such as changing the color of a filled shape on the raster representation. After preparing the raster representation during step 1920, the image processor 316 can move to step 1922.

At step 1922, the image processor 316 can prepare a print job for the RIP 302. As described above, the print job can include PDL and/or PJL commands that identify elements of the page. Here, the image processor 316 can include the raster representation as an image file in the print job, as well as PDL/PJL commands about how to render the raster representation. The image processor 316 can also include commands about identified text objects, such as PDL commands that identify current attributes about an identified text object such as its content, font, and location, as well as wrapped PJL commands that indicate how the text object should be modified to apply selected object effects 504 to the text object. The print job can further include other commands regarding additional transformation effects 400.

At step 1924, the scanner processor 306 can pass the print job to the printer's local RIP 302, or a remote cloud RIP 302. The RIP 302 can follow the commands in the print job to apply the transformation effects 400 identified in the print job and generate an orderlist that indicates to the print engine 304 how to print the page as modified by the transformation effects 400. In some embodiments, the RIP 302 can follow steps described above with respect to FIGS. 13A-13B to generate an orderlist from the print job commands. By way of a non-limiting example a PDL Interpreter 310 can modify the raster representation sent as an image file in the print job as specified by any of the selected transformation effects 400. By way of another non-limiting example, the Graphics Rendering Component 312 can apply an object effect 504 to an identified text object by rendering new text over the underlying raster image that corresponds to the content of the identified text object using a different font, font size, and/or position on the page. The RIP 302 can pass the orderlist it generates to the print engine 304 at step 1926 to be printed.

Returning to step 1918, if the scanner processor 306 chooses to move to step 1928 to process object effects 504 related to text itself, the image processor 316 can perform some or all selected page effects 502 on the scanned raster representation at step 1928, such as adjusting the page size.

At step 1930, the image processor 316 can interpolate the background behind a text object, such as copying the color or pattern of surrounding pixels.

At step 1932, the image processor 316 can delete the existing text object on the raster representation. In some embodiments the image processor 316 can generate a box filled with the interpolated background color or pattern, and overlay that box over the existing text object such that it is no longer visible on the raster representation. In other embodiments the image processor 316 can erase the text object and fill its former space with the interpolated background color or pattern.

At step 1934, the image processor 316 can generate a new text object with the same content as the deleted text object, but with different attributes to apply the selected object effects 504. By way of a non-limiting example, the image processor 316 can render a new text object using a different font, font size, and/or font color. The new text object can be placed at the original location of the deleted text object, or be placed at a different location on the page, as specified by selected transformation effects 400.

At step 1936, the image processor 316 can apply any other selected transformation effects to the raster representation, such as remaining page effects 502, object effects 504 on other non-text objects, imaging filters 506, and/or pixmap blending masks 508.

After applying the selected transformation effects on the raster representation, the scanner processor 306 can pass the altered raster representation to the print engine at step 1910 to be printed. In some embodiments or situations, the scanner processor 306 can additionally inform the print engine 304 of any remaining selected transformation effects 400 that are to be applied at the print engine 304 during step 1910, such as pixmap screens 510.

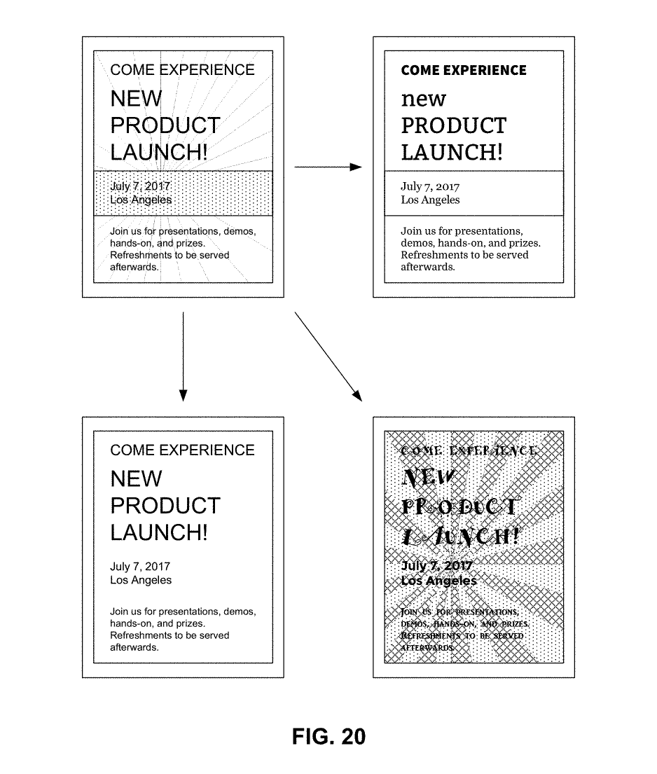

As described above, the system and methods described above can be used to create one or more variants of an original digital or hard copy document such that the variants can be printed at the printer 100. By way of a non-limiting example, FIG. 20 depicts an example of an original document at the top left, which can be modified using one or more transformation effects 400 to create variants of the document. In this example the copy on the top right has altered fonts and altered background patterns relative to the original, the copy on the bottom left the same fonts but has the original's background images removed, and the copy on the bottom right has the same text content as the original but is rendered with different fonts, altered background fill patterns, and a removed center stripe shape. A user can select different sets of transformation effects 400 to apply to different sets of copies, such that any number of any or all of the page variants shown in FIG. 20 can be printed from the same original page.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. A method of printing a document variant at a printer, comprising:
receiving page data at a printer that describes elements of a page; receiving one or more transformation effect selections at the printer that indicate modifications to the elements of the page;
digitally modifying the elements of the page at the printer prior to printing according to the transformation effect selections; and
printing the page with the printer according to the modified elements.

2. The method of claim 1, wherein each transformation effect is one of: a page effect that modifies at least one global setting for the page; an object level effect that modifies at least one parameter for one or more individual elements on the page; an imaging filter that modifies at least one parameter for a group of elements on the page; a pixmap blending mask that is overlaid on other elements on the page; and a pixmap screen that alters the appearance of the page immediately before printing the page.

3. The method of claim 1, wherein a different set of transformation effects is applicable to different ranges of copies of the page.

4. The method of claim 1, wherein the page data and the transformation effect selections are received by the printer as commands within a print job submitted by a printer driver on another device.

5. The method of claim 4, wherein the page data is represented with page description language commands and the transformation effect selections are represented as printer job language commands.

6. The method of claim 4, wherein the printer comprises a page description language interpreter, a graphics rendering component, and a print engine, wherein the page description language interpreter converts commands in the print job into a format expected by the graphics rendering component, the graphics rendering component generates low level instructions for the print engine in an orderlist from the converted commands, and the print engine follows the orderlist to print the page.

7. The method of claim 6, wherein the page description language interpreter converts commands in the print job according to one or more transformation effects that modify existing parameters in the print job about the page and/or individual objects.

8. The method of claim 6, wherein the graphics rendering component generates and adds low level instructions to the orderlist that will cause the print engine to print new elements on the page according to one or more transformation effects.

9. The method of claim 4, wherein the printer is in at least selective data communication with a remote raster image processor over a network, and the printer is configured to submit the print job to the remote raster image processor such that the remote raster image processor:
applies the transformation effect selections to create a variant page by modifying parameters in the print job about the page and/or individual objects, and/or adding new objects;
generates an orderlist of low level instructions for printing the page variant; and
returns the orderlist to the printer,
wherein the printer comprises a print engine configured to follow the orderlist to print the page variant.

10. The method of claim 1, wherein the printer comprises scanner components comprising an image sensor configured to scan the page, an input device through which the transformation effects selections are input by a user, and image processor configured to digitally modify elements of the page according to the transformation effects.

11. The method of claim 10, wherein:
the printer further comprises a page description language interpreter, a graphics rendering component, and a print engine; and the image processor sends information about the page and the transformation effect selections as commands in a print job to the page description language interpreter, such that:
the page description language interpreter converts commands in the print job into a format expected by the graphics rendering component, modifying command parameters according to transformation effect selections;
the graphics rendering component generates low level instructions for the print engine in an orderlist from the converted commands, generating and adding low level instructions for transformation effect selections that add new elements to the page; and
the print engine follows the orderlist to print the page.

12. The method of claim 10, wherein the image processor digitally modifies one or more elements of the page according to the transformation effect selections and generates an orderlist comprising low level instructions for printing out the modified page, and passes the orderlist to a print engine at the printer that is configured to follow the orderlist to print the modified page.

13. The method of claim 10, wherein the printer further comprises an optical character recognition component configured to detect and recognize text within the page, such that the text is an object modifiable according to the transformation effects.

14. The method of claim 13, wherein the transformation effects are applied to recognized text by interpolating a background behind the recognized text and covering up the recognized text with the interpolated background, and rendering new text with the same content according to the transformation effects.

15. A printer, comprising:
a page description language interpreter configured to:
receive a print job comprising page data commands describing elements of a page and effect commands that indicate one or more selected transformation effects, adjust parameters of page data commands according to transformation effects to modify the appearance of the page and/or individual objects on the page; and
convert the commands into an expected format;
a graphics rendering component configured to generate an orderlist from the commands converted into the expected format, the orderlist comprising low level instructions for printing the page, wherein the graphics rendering component generates and adds low level instructions to the orderlist regarding transformation effects that add new elements to the page; and
a print engine configured to follow the low level instructions in the orderlist to print the page using one or more printer components.

16. The printer of claim 15, wherein each transformation effect is one of: a page effect that modifies at least one global setting for the page; an object level effect that modifies at least one parameter for one or more individual elements on the page; an imaging filter that modifies at least one parameter for a group of elements on the page; a pixmap blending mask that is overlaid on other elements on the page; and a pixmap screen that alters the appearance of the page immediately before printing the page.

17. The printer of claim 15, wherein a different set of transformation effects is applicable to different ranges of copies of the page.

18. A printer, comprising:
scanner components comprising at least one image sensor that are configured to scan a physical page into a digital representation of the page;
an input device configured to accept one or more transformation effect selections from a user;
an image processor configured to digitally modify the digital representation of the page according to the transformation effect selections;
a page description language interpreter configured to:
receive a print job comprising page data commands describing elements of a page and effect commands that indicate one or more selected transformation effects, adjust parameters of page data commands according to transformation effects to modify the appearance of the page and/or individual objects on the page; and
convert the commands into an expected format
a graphics rendering component configured to generate an orderlist from the commands converted into the expected format, the orderlist comprising low level instructions for printing the page, wherein the graphics rendering component generates and adds low level instructions to the orderlist regarding transformation effects that add new elements to the page; and a print engine configured to follow the low level instructions in the orderlist to print the page using one or more printer components.

19. The printer of claim 18, wherein each transformation effect is one of: a page effect that modifies at least one global setting for the page; an object level effect that modifies at least one parameter for one or more individual elements on the page; an imaging filter that modifies at least one parameter for a group of elements on the page; a pixmap blending mask that is overlaid on other elements on the page; and a pixmap screen that alters the appearance of the page immediately before printing the page.

20. The printer of claim 18, wherein a different set of transformation effects is applicable to different ranges of copies of the page.
